(19) United States
(12) Patent Application Publication
(10) Pub. No.: US 2025/0199682 A1
(43) Pub. Date: Jun. 19, 2025

(54) DEVICES AND METHODS FOR IMPLICIT PLACEMENT OF HOST DATA WITHOUT HOST INTERVENTION

(71) Applicant: SK Hynix NAND Product Solutions Corp. (dba Solidigm), Rancho Cordova, CA (US)

(72) Inventors: Jonathan Hughes, Longmont, CO (US); John Rudelic, Folsom, CA (US)

(21) Appl. No.: 18/542,056

(22) Filed: Dec. 15, 2023

(51) Int. Cl. G06F 3/06

(52) U.S. Cl. CPC G06F 3/0607; G06F 3/0647; G06F 3/0671

(57) ABSTRACT

A device, non-transitory computer-readable medium and related method, the device including memory and a processing circuitry. Processing circuitry, which is communicatively coupled to the memory, receives a write request from a host, the write request including information indicative of system characteristics and a destination address at which to store data. Processing circuitry determines the system characteristics based on the information indicative of the system characteristics and determines whether any of the system characteristics match with mapped system characteristics of a data placement table, wherein each mapped system characteristic corresponds to a respective placement identification (ID). Processing circuitry determines a location in memory at which to store the data based on one or more placement IDs corresponding to matched mapped system characteristics of the data placement table and without regard to the destination address, and causes the data to be stored at the location.

### TECHNICAL FIELD

The present disclosure is directed to devices and methods for data placement within memory.

### SUMMARY

In accordance with the present disclosure, devices and methods are provided for performing implicit data placement by directing write requests to a subset of memory based on certain system characteristics. The device includes memory, which may include memory blocks with pages or super pages of memory. The device and method disclosed herein may employ the use of a data placement table or suitable mapping structure to associate a mapped system characteristic to a respective placement identification (ID). This implicit data placement using a data placement table enables the device to provide flexible data placement (FDP) capabilities for storage workloads without additional latency. FDP is a Nonvolatile Memory Express (NVMe) mechanism that enables a host to cause data to be stored in a physical subset of memory within a device communicatively coupled to the host. Typically, for certain workloads, FDP requires the host to interrupt the device operations to inject a placement ID, causing the device to store the data at an available memory address associated with the injected placement ID. This form of data placement may cause consistent latency and limitations for workloads that use large write streams, reducing the overall performance of the device. The device and methods disclosed herein remove the need for host interruption of placement ID injection by using a locally stored data placement ID for the implicit routing of write requests to certain subsets of memory.

The device may include processing circuitry, which is configured to receive a write request from a host and determine one or more system characteristics based on information of the write request indicative of the system characteristics. The processing circuitry is also configured to determine whether one or more of the system characteristics from the write request matches with any one of the mapped system characteristics of the data placement table. When a match is determined, processing circuitry determines a location in the memory (e.g., memory address) at which to store the data of the write request based on the corresponding placement ID of the matched mapped system characteristic and without regard to the destination address. Lastly, the processing circuitry stores the data at the determined location within memory. This device and the methods provided herein improve the overall write performance and data placement by the processing circuitry of the device (e.g., a solid-state drive (SSD) device).

In some embodiments, the device (e.g., a storage device) is provided with a memory and processing circuitry that are communicatively coupled to each other. In some embodiments, the processing circuitry receives write requests indicating data is to be stored at an associated destination address within the memory. In some embodiments, the write request received by the processing circuitry includes information indicative of one or more system characteristics, which are to be used by processing circuitry with the data placement table, and a destination memory address which corresponds to a memory address of memory at which to store the data.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations and do not necessarily all refer to the same embodiment. However, they are also not necessarily mutually exclusive.

FIG. 1 shows an illustrative diagram of a system that includes a host and a device with processing circuitry and memory, in accordance with some embodiments of the present disclosure;

FIG. 2 shows another illustrative diagram that shows a system including a host and a device, in accordance with some embodiments of the present disclosure;

FIG. 3 shows an additional illustrative diagram of a system with multiple hosts and a device, in accordance with some embodiments of the present disclosure;

FIG. 4 shows a flowchart of illustrative steps for performing implicit data placement, in accordance with some embodiments of the present disclosure; and

FIG. 5 shows a flowchart of illustrative steps of a subprocess for performing implicit data placement for data associated with unmapped system characteristics, in accordance with some embodiments of the present disclosure.

### DETAILED DESCRIPTION

In accordance with the present disclosure, systems and methods are provided for performing implicit placement of data within memory of a device (e.g., an SSD device) using a data placement table. The device (e.g., an SSD device) may include multiple memory dies (e.g., NAND memory dies), and the device is configured to perform garbage collection while receiving I/Os (e.g., write requests) from multiple tenants and/or hosts. If a first host has a greater write request velocity or write request volume than the other hosts that are communicatively coupled to the device, the device may be required to perform background garbage collection on memory addresses that store data from the hosts with slower write request velocity or smaller write request volume. This increase in garbage collection is needed in order to accommodate the I/Os (e.g., write requests) from the first host. This results in write amplification by repeatedly copying data to accommodate data from the first host, and the write amplification may cause performance and endurance issues of the memory dies of the device.

In some examples of a system with a device communicatively coupled to a host, the host may include multiple virtual machines or applications that are unaware that the other virtual machines or applications may access the memory of the device. Using a data placement table on the device to determine a respective placement identification (ID) of the memory at which to store data of a respective write request enables the device to perform implicit data placement by directing write requests to a subset of memory based on certain system characteristics. An example system characteristic that may be determined from the write request is a submission queue ID. In such an example, each virtual machine or application may correspond to a unique submission queue ID to indicate the virtual machine or application from which the write request was sent. Processing circuitry receives the write request and uses the data placement table in order to determine a placement ID of memory at which other data of similar write requests have been stored. In some embodiments, the implicit data placement performed by the processing circuitry of the device may be used for storage workloads and computing workloads without delays in the write request path in the host with multiple virtual machines or multiple applications.

The features of the disclosure described herein are in the context of a device (e.g., an SSD device) having processing circuitry and memory. However, the principles of the present disclosure may be applied to any other suitable context in which implicit data placement is performed by directing write requests to a subset of memory based on certain system characteristics. The device may include memory and processing circuitry, and the processing circuitry and memory are communicatively coupled to each other by a network bus or interface. In some embodiments, the processing circuitry receives a write request, determines a placement ID of the memory at which to store data associated with the write request based on at least one system characteristic, and causes to store the data at a location in memory according to the determined placement ID. In some embodiments, the request is sent from a host to the device via a network bus or interface.

In particular, the present disclosure provides devices and methods that perform implicit data placement in order to allow the device (e.g., an SSD device) to provide data placement with improved performance and without additional latency in the I/O path (e.g., the write request path). This enables FDP placement mode to be implemented in compute workload applications as well as storage workload applications.

In some embodiments, a processor of the processing circuitry may be a highly parallelized processor capable of handling high bandwidths of incoming data quickly (e.g., by starting simultaneous processing of write requests or instructions before completion of previously received write requests or instructions).

In some embodiments, the memory of the device disclosed herein may contain any of the following memory densities: single-level cells (SLCs), multi-level cells (MLCs), triple-level cells (TLCs), quad-level cells (QLCs), penta-level cells (PLCs), and any suitable memory density that is greater than five bits per memory cell.

In some embodiments, the system and methods of the present disclosure may refer to a storage device system (e.g., an SSD storage system), which includes a storage device such as a solid-state drive device, which is communicatively coupled to a host (e.g., a host device) by a network bus or interface.

An SSD is a data storage device that uses integrated circuit assemblies as memory to store data persistently. SSDs have no moving mechanical components, and this feature distinguishes SSDs from traditional electromechanical magnetic disks, such as hard disk drives (HDDs) or floppy disks, which contain spinning disks and movable read/write heads. Compared to electromechanical disks, SSDs are typically more resistant to physical shock, run silently, have lower access time, and less latency.

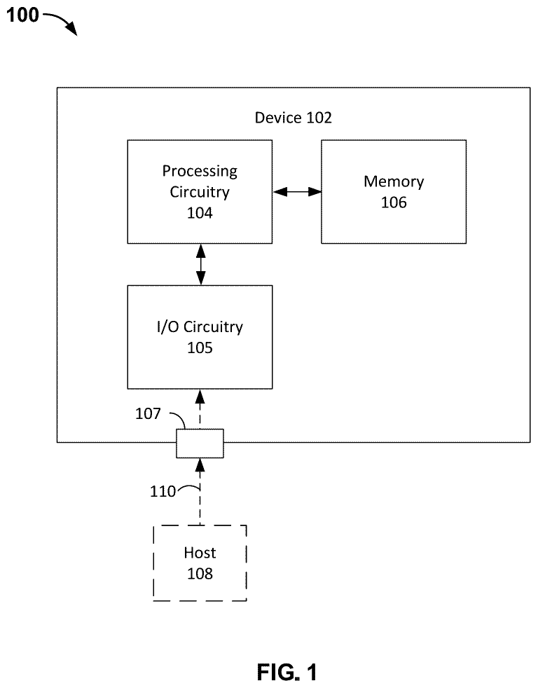

The subject matter of this disclosure may be better understood by reference to FIGS. 1-5.

FIG. 1 shows an illustrative diagram of a system 100 which includes a host 108 and device 102 with processing circuitry 104, input/output (I/O) circuitry 105, and memory 106, in accordance with some embodiments of the present disclosure. In some embodiments, device 102 may be a storage device such as a solid-state storage device (e.g., an SSD device). In some embodiments, processing circuitry 104 may include a processor or any suitable processing unit. In some embodiments, memory 106 may be non-volatile memory. It will be understood that the embodiments of the present disclosure are not limited to SSDs. For example, in some embodiments, device 102 may include a hard disk drive (HDD) device in addition to or in place of an SSD. In some embodiments, I/O circuitry 105 includes temporary memory (e.g., cache or any suitable volatile memory) to store received write requests (e.g., write request 110) via port 107.

In some embodiments, the processing circuitry 104 is configured to receive write requests (e.g., write request 110) from host 108, where each write request 110 includes information indicative of system characteristics and a destination address at which to store the data in memory 106. In some embodiments, the system characteristics may include any one or more of a physical function, a virtual function, a namespace ID, a submission queue ID, a write operation length (or size), and a port ID (e.g., in embodiments with multiple ports such as port 107). The processing circuitry 104 determines the system characteristics associated with a write request 110 based on the information indicative of the system characteristics. The write request 110 indicates to the processing circuitry 104 that the corresponding data of the write request 110 is to be stored at a memory address of the memory 106. In some embodiments, processing circuitry 104 stores the corresponding data of the write request 110 based on the system characteristics (e.g., physical function, a virtual function, a namespace ID, a submission queue ID, a write operation length (or size), and a port ID). The processing circuitry 104 may refer to a data placement table with mapped system characteristics, each mapped system characteristic with a respective placement identification (ID). In some embodiments, the data placement table is temporarily stored and accessed in processing circuitry 104. In some embodiments, the data placement table may be stored in memory 106. In some embodiments, write request 110 is transmitted on a network bus or interface to processing circuitry 104 via I/O circuitry 105. In some embodiments, write request 110 is transmitted from an external source (e.g., a host 110 that is communicatively coupled to device 102 via port 107). The processing circuitry 104 may receive write requests (e.g., write request 110) from both internal and external sources of the device 102. In some embodiments, I/O circuitry 105 includes volatile memory, which is configured to temporarily store any outstanding write requests (e.g., request 110) that are to be processed by processing circuitry 104. In some embodiments, the device may receive any one of NVMe write requests, Peripheral Component Interconnect Express (PCIe) write requests, and write requests of any other suitable interface protocol.

Additionally, device 102 includes memory 106. In some embodiments, memory 106 includes any one or more of a non-volatile memory, such as Phase Change Memory (PCM), a PCM and switch (PCMS), a Ferroelectric Random Access Memory (FeRAM), or a Ferroelectric Transistor Random Access Memory (FeTRAM), a Memristor, a Spin-Transfer Torque Random Access Memory (STT-RAM), and a Magnetoresistive Random Access Memory (MRAM), any other suitable memory, or any combination thereof. In some embodiments, memory 106 is of a memory density, the memory density is any one of (a) single-level cell (SLC) memory density, (b) multi-level cell (MLC) memory density, (c) tri-level cell (TLC) memory density, (d) quad-level cell (QLC) memory density, (e) penta-level cell (PLC) memory density, or (f) a memory density of greater than 5 bits per memory cell. In some embodiments, processing circuitry 104 is communicatively coupled to memory 106 to store and access data in memory blocks or pages. In some embodiments, a data bus interface is used to transport write/read instructions or data.

In some embodiments, device 102 also includes volatile memory, which may include any one or more volatile memory, such as Static Random Access Memory (SRAM). In some embodiments, volatile memory is configured to temporarily store data (e.g., write request 110) during execution of operations by processing circuitry 104. In some embodiments, each of processing circuitry 104 and I/O circuitry 105 is communicatively coupled to volatile memory to store and access write request 110 data of the volatile memory. In some embodiments, a data bus interface is used to transport write request 110 data from volatile memory to processing circuitry 104. In some embodiments, volatile memory is communicatively coupled to memory 106, the volatile memory configured to function as a cache or temporary memory storage for memory 106. In some embodiments, a data bus interface between memory 106 and volatile memory provides a network bus for accessing or writing data to or from memory 106.

In some embodiments, the processor or processing unit of processing circuitry 104 may include a hardware processor, a software processor (e.g., a processor emulated using a virtual machine), or any combination thereof. The processor, also referred to herein as processing circuitry 104, may include any suitable software, hardware, or both for controlling memory 106 and processing circuitry 104. In some embodiments, device 102 may further include a multi-core processor. Memory 106 may also include hardware elements for non-transitory storage of instructions, commands, or requests.

Processing circuitry 104 is configured to perform implicit data placement by directing write requests to a subset of memory 106 based on certain system characteristics by receiving write requests (e.g., write request 110) from host 108 and determining one or more system characteristics based on information indicative of the system characteristics included within each write request 110. Write request 110 may originate from host 108 and include data to be stored in memory 106 as well as a destination address indicative of a memory address of memory 106 at which to store the data. Processing circuitry 104 determines if any one or more system characteristic matches with mapped system characteristics of the data placement table. The data placement table includes at least one mapped system characteristic, each mapped system characteristic corresponding to a respective placement identification (ID). In some embodiments, the placement ID refers to a memory address of a particular subset of memory within one or more of the memory dies of memory 106. For example, each placement ID may point to a respective memory address of a memory block or page of a respective memory die (e.g., NAND memory). If none of the determined one or more system characteristics matches with the mapped system characteristics of the data placement table, processing circuitry 104 maps the determined one or more system characteristics to an available placement ID, and stores the system characteristic-placement ID pair into the data placement table for the processing of subsequent write requests. In some embodiments, available placement IDs may correspond to memory blocks or pages that have not been written to or contain stale or invalid data that may be overwritten or cleared. In some embodiments, the data placement table may be initialized with initial mapped system characteristics corresponding to respective placement IDs, rather than initializing mapping system characteristics to placement IDs in real-time as write requests (e.g., write request 110) are received and processed. In addition, the data placement table may include a configured default placement ID which is used when the processing circuitry determines that one or more system characteristics of a write request (e.g., write request 110) do not match with any of the mapped system characteristics in the data placement table.

When the determined one or more system characteristic matches with the mapped characteristics of the data placement table, processing circuitry 104 then determines a location (e.g., a memory address) in memory 106 at which to store the data of the write request 110 based on one or more placement IDs corresponding to the matched mapped system characteristics of the data placement table and without considering the destination address included within the write request 110. In some embodiments, when there is more than one placement ID determined based on matched system characteristics, processing circuitry 104 may randomly select one of the placement IDs at which to store the data of the write request 110. In other embodiments, processing circuitry 104 determines one placement ID that corresponds to matched mapped system characteristics. Once processing circuitry 104 determines the location in memory at which to store the data, processing circuitry 104 then causes the data to be stored at the location (e.g., the memory address corresponding to the determined placement ID). In some embodiments, the write request 110 may be one of multiple write requests (e.g., a stream of write requests). In such embodiments, the processing circuitry 104 may determine that each write request 110 of the stream of write requests includes data indicative of the same system characteristics which match with the same mapped system characteristic, therefore the respective data of each write request is sequentially stored, by processing circuitry 104, within a subset of memory 106 associated with the same placement ID.

In some embodiments, device 102 may be a storage device (for example, SSD device) which may include one or more packages of memory dies (e.g., memory 106), where each die includes storage cells. In some embodiments, the storage cells are organized into pages or super pages, such that pages and super pages are organized into blocks, each page or super page of a respective placement ID. In some embodiments, each storage cell can store one or more bits of information.

For purposes of clarity and brevity, and not by way of limitation, the present disclosure is provided in the context of performing implicit data placement without intervention from the host and without regard to the respective destination address of each write request 110. By using a data placement table with mapped system characteristics and corresponding placement IDs, processing circuitry 104 stores the data associated with write requests (e.g., write request 110) received from host 108 without regard to the destination address of each respective write request. The process of performing implicit data placement by directing write requests to a subset of memory based on certain system characteristics may be configured by any suitable software, hardware, or both for implementing such features and functionalities. Performing implicit data placement, as disclosed, may be at least partially implemented in, for example, device 102 (e.g., as part of processing circuitry 104, or any other suitable device). For example, for a solid-state storage device (e.g., device 102), performing implicit data placement may be implemented in processing circuitry 104. The implicit data placement using a data placement table and system characteristics enables device 102 to provide data placement capabilities without additional latency from host 108 in the I/O path of write requests (e.g., write request 110). This allows FDP placement modes to be used for computational workloads as well as storage workloads (e.g., write request 110).

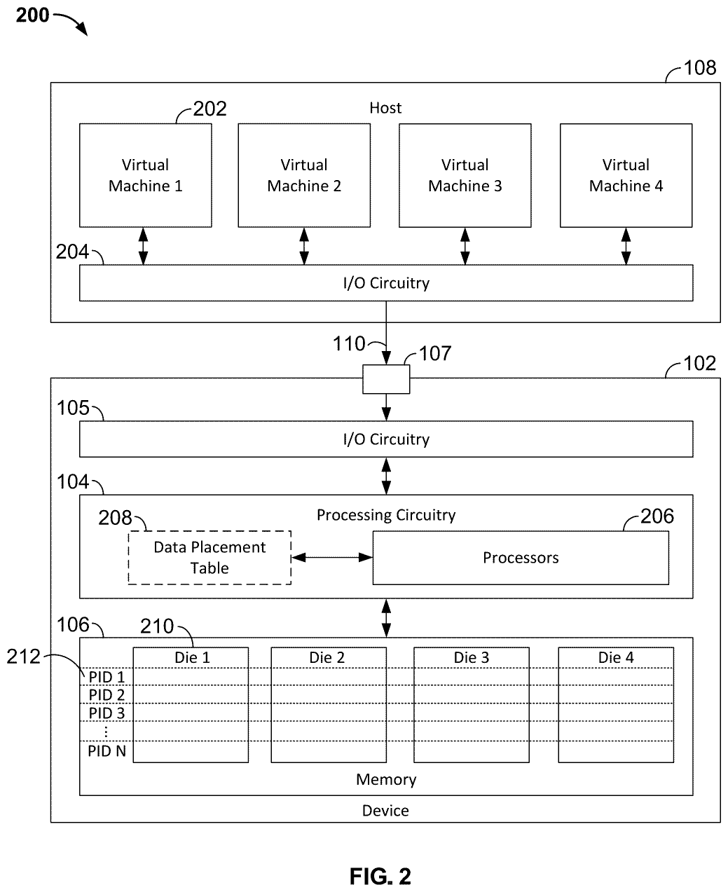

FIG. 2 shows another illustrative diagram of a system 200 including a host 108 and a device 102, in accordance with some embodiments of the present disclosure. Host 108 includes I/O circuitry 204 and four virtual machines 202 (e.g., virtual machines 1-4) such that the I/O circuitry 204 is communicatively coupled to each of the virtual machines 202. Host 108 is configured to transmit a write request 110 from one of the virtual machines 202 through the I/O circuitry 204. System 200 also includes device 102, which includes port 107, I/O circuitry 105, processing circuitry 104 and memory 106, similar to device 102 in FIG. 1. The processing circuitry 104 includes at least one processor 206. In some embodiments, the processing circuitry 104 includes the data placement table 208 which is used to map one or more system characteristics to a corresponding placement ID. In some embodiments, the data placement table may be stored in memory 106, at which processing circuitry 104 may still access the data placement table 208. In some embodiments, data placement table 208 may be implemented in firmware of device 102 such as the device transport layer. In such embodiments, the transport layer is configured to receive I/Os (e.g., write request 110 and other appropriate commands) from the virtual machines 202, determine a respective placement ID 212 of memory 106 of which the I/O may access and inject the determined placement ID 212 into the I/O. Additionally, the data placement table 208 may be implemented in hardware, software, or any combination thereof.

Memory 106 includes memory dies 210 (e.g., die 1, die 2, die 3, and die 4). In addition, memory 106 may be partitioned by a number of placement IDs 212 (e.g., PID 1-N). In some embodiments, any available placement ID 212 may be used in the data placement table, the available placement ID 212 mapped to one or more corresponding system characteristics. In some embodiments, memory 106 may include any suitable number of memory dies 210 and any suitable number of placement IDs 212 to store data associated with write requests received from host 108. In some embodiments, memory 106 includes any one or more of a non-volatile memory, such as Phase Change Memory (PCM), a PCM and switch (PCMS), a Ferroelectric Random Access Memory (FeRAM), or a Ferroelectric Transistor Random Access Memory (FeTRAM), a Memristor, a Spin-Transfer Torque Random Access Memory (STT-RAM), and a Magnetoresistive Random Access Memory (MRAM), any other suitable memory, or any combination thereof. In some embodiments, memory 106 is of a memory density, the memory density is any one of (a) single-level cell (SLC) memory density, (b) multi-level cell (MLC) memory density, (c) tri-level cell (TLC) memory density, (d) quad-level cell (QLC) memory density, (e) penta-level cell (PLC) memory density, or (f) a memory density of greater than 5 bits per memory cell. In some embodiments, processing circuitry 104 is communicatively coupled to memory 106 to store and access data in memory blocks or pages.

Host 108 may include a respective submission queue between each virtual machine 202 and the I/O circuitry 204 in order to temporarily store write requests 110 between a respective virtual machine and the I/O circuitry 204, each submission queue with a unique submission queue ID. In some embodiments, the submission queue ID of a submission queue at which a write request was stored may be one of the one or more system characteristics included within the write request. In some embodiments, the write request (e.g., write request 110) may include information indicative of one or more other system characteristics including any one or more of a physical function associated with the respective virtual machine 202, a virtual function associated with the respective virtual machine 202, a namespace ID corresponding to a source memory address of the data associated with the write request 110, a write operation length (or size) of the write request 110 and a port ID of the device 102 which received the write request.

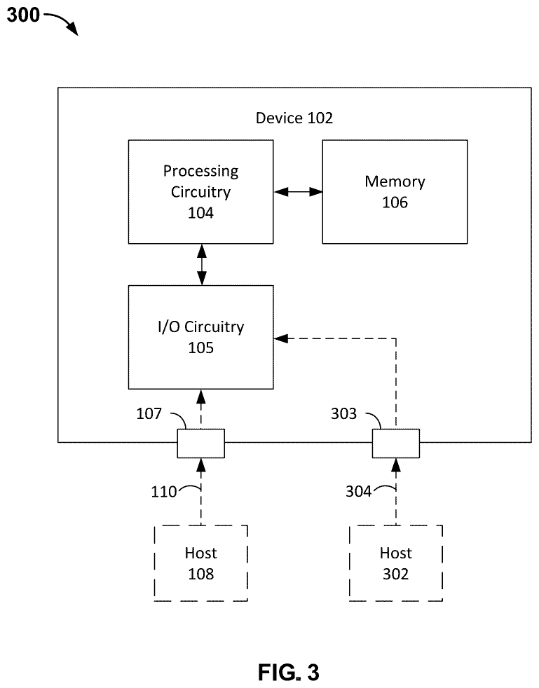

FIG. 3 shows an additional illustrative diagram of a system 300 with multiple hosts (e.g., host 108 and host 302) and a device 102, in accordance with some embodiments of the present disclosure. The device 102 includes two ports (e.g., port 107 and port 303). Port 107 is coupled to host 108 and port 303 is coupled to host 302. The I/O circuitry 105 is configured to receive write requests (e.g., write requests 110 and 304) from host 108 and host 302 via port 107 and port 303, respectively. Similarly to device 102 in FIG. 1, device 102 may be a storage device such as a solid-state storage device (e.g., an SSD device). In some embodiments, processing circuitry 104 may include a processor or any suitable processing unit. In some embodiments, memory 106 may be non-volatile memory. In some embodiments, I/O circuitry 105 includes temporary memory (e.g., cache or any suitable volatile memory) to store received write requests (e.g., write request 110 and write request 304) via port 107 and port 303.

The processing circuitry 104 is configured to receive write requests (e.g., write request 110 and write request 304) from host 108 and host 302, where each write request includes information indicative of system characteristics and a destination address at which to store the data in memory 106. In some embodiments, the system characteristics may include any one or more of a physical function, a virtual function, a namespace ID, a submission queue ID, a write operation length (or size), and a port ID. The processing circuitry 104 determines the system characteristics associated with a write request (e.g., write request 110 and write request 303) based on the information indicative of the system characteristics. The received write request indicates to the processing circuitry 104 that the corresponding data of the write request (e.g., write request 110 or write request 304) is to be stored at a memory address of the memory 106. In some embodiments, processing circuitry 104 stores the corresponding data of the write request based on the system characteristics (e.g., physical function, a virtual function, a namespace ID, a submission queue ID, a write operation length (or size), and a port ID). The processing circuitry 104 may refer to a data placement table with mapped system characteristics, each mapped system characteristic with a respective placement identification (ID).

In some embodiments, a write request (write request 110 and write request 304) is transmitted from one or more external sources (e.g., a host 110 that is communicatively coupled to device 102 via port 107 and host 302 that is communicatively coupled to device 102 via port 303). The processing circuitry 104 may receive write requests (e.g., write request 110 and write request 304) from both internal and external sources of device 102. In some embodiments, I/O circuitry 105 includes volatile memory, which is configured to temporarily store any outstanding write requests that are to be processed by processing circuitry 104. In some embodiments, device 102 may include more than two ports. In some embodiments, I/O circuitry 105 may be communicatively coupled to more than two hosts. In some embodiments, host 108 and host 302 may each be implemented as a virtual machine on a single host. In some embodiments, host 108 and host 302 may each be an application performed on a single host.

Additionally, device 102 includes memory 106, as shown in FIG. 1. In some embodiments, processing circuitry 104 is communicatively coupled to memory 106 to store and access data in memory blocks or pages. In some embodiments, a data bus interface is used to transport write/read instructions or data. In some embodiments, device 102 also includes volatile memory, which may include any one or more volatile memory, such as Static Random Access Memory (SRAM). In some embodiments, volatile memory is configured to temporarily store data (e.g., write request 110 and write request 304) during execution of operations by processing circuitry 104. In some embodiments, a data bus interface between memory 106 and volatile memory provides a network bus for accessing or writing data to or from memory 106.

Processing circuitry 104 is configured to perform implicit data placement by directing write requests to a subset of memory 106 based on certain system characteristics by receiving write requests (e.g., write request 110 and write request 304) from host 108 and host 302, and determining one or more system characteristics based on information indicative of the system characteristics included within each write request. Each of write request 110 and write request 304 may include data to be stored in memory 106 as well as a destination address indicative of a memory address of memory 106 at which to store the data. In some embodiments, write request 304 may be one among a write stream of write requests from host 302. In such embodiments, each write stream of the write stream which includes write request 304 may include one or more system characteristics which cause the respective data of each write request to be stored at a placement ID of memory 106 which corresponds to a mapped system characteristic in the data placement table which matches the one or more system characteristic of the write requests.

When the determined one or more system characteristic matches with the mapped characteristics of the data placement table, processing circuitry 104 then determines a location (e.g., a memory address) in memory 106 at which to store the data of the write request 110 based on one or more placement IDs corresponding to the matched mapped system characteristics of the data placement table and without considering the destination address included within the write request (e.g., write request 110 and write request 302).

In some embodiments, device 102 may be a storage device (for example, SSD device) which may include one or more packages of memory dies (e.g., memory 106), where each die includes storage cells. In some embodiments, the storage cells are organized into pages or super pages, such that pages and super pages are organized into blocks, each page or super page of a respective placement ID. In some embodiments, each storage cell can store one or more bits of information.

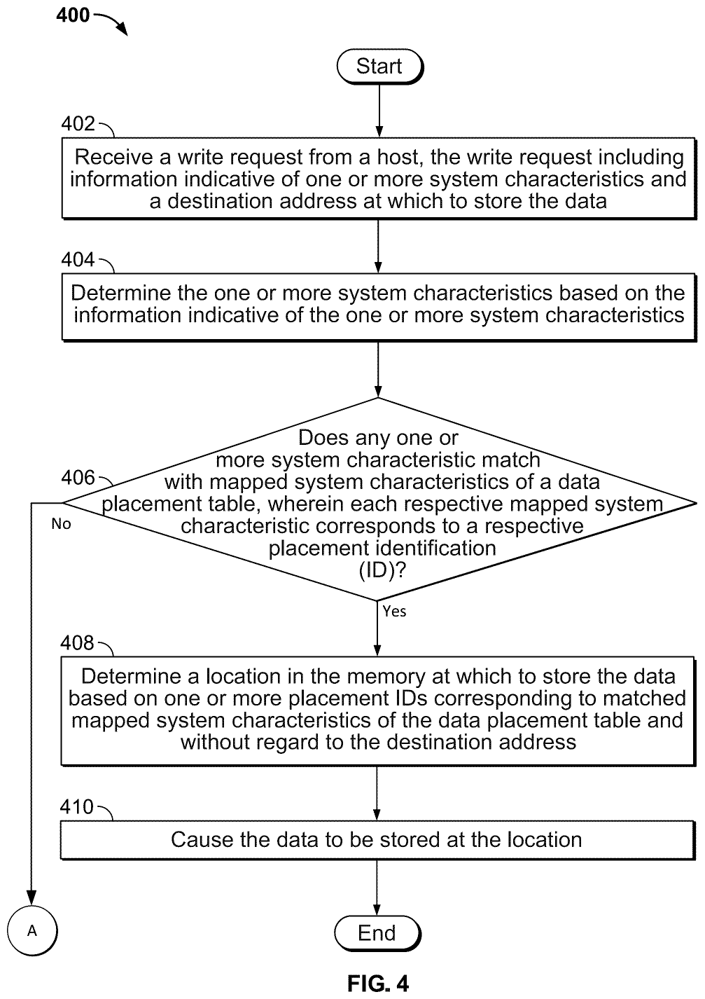

FIG. 4 shows a flowchart of illustrative steps of process 400 for performing implicit data placement, in accordance with some embodiments of the present disclosure. In some embodiments, the referenced system, device, processing circuitry, I/O circuitry, memory, port, host, and write request may be implemented as system 100, device 102, processing circuitry 104, I/O circuitry 105, memory 106, port 107, host 108, and write request 110, respectively. In some embodiments, the process 400 can be modified by, for example, having steps rearranged, changed, added, and/or removed.

At step 402, processing circuitry receives a write request from a host, where the write request includes information indicative of one or more system characteristics and a destination address at which to store the data. In some embodiments, the destination address is a memory address of the memory within the device. The write request may originally be received by I/O circuitry via the port of the device. In some embodiments, the write request is transmitted on a network bus or interface to processing circuitry via I/O circuitry. The I/O circuitry may include temporary storage or a cache to store outstanding write requests received from the host before each write request is processed by processing circuitry. Once the processing circuitry receives the write request from a host, the processing circuitry determines one or more system characteristics based on information included within the write request, at step 404.

At step 404, processing circuitry determines one or more system characteristics based on the information indicative of one or more system characteristics. In some embodiments, the system characteristics may include any one or more of a physical function, a virtual function, a namespace ID, a submission queue ID, a write operation length (or size), and a port ID (e.g., in embodiments of a device with more than one port). The write request indicates to the processing circuitry that the corresponding data of the write request is to be stored at a memory address of the memory. Nevertheless, processing circuitry stores the corresponding data of the write request based on the system characteristics (e.g., physical function, a virtual function, a namespace ID, a submission queue ID, a write operation length (or size), and a port ID). The processing circuitry may refer to a data placement table with mapped system characteristics, each mapped system characteristic with a respective placement ID, as shown at step 406.

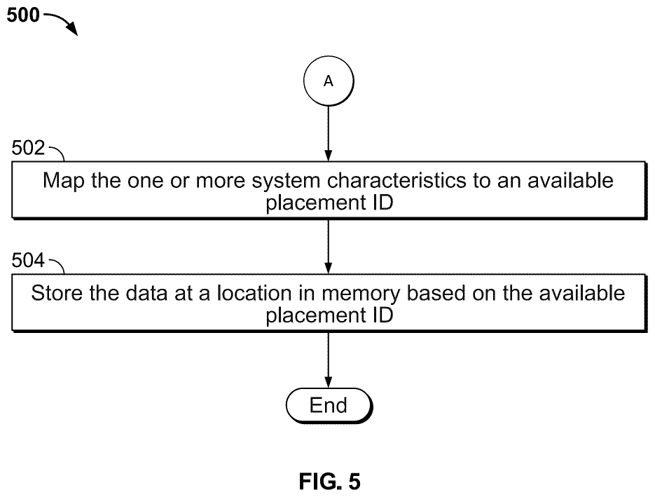

At step 406, processing circuitry determines whether any one or more system characteristics match with mapped system characteristics of a data placement table, wherein each respective mapped system characteristic corresponds to a respective placement identification (ID). In some embodiments, the processing circuitry compares each of the one or more system characteristics with each of the mapped system characteristics of the data placement table to determine whether there is a match. In some embodiments, the processing circuitry may use any appropriate method to compare a system characteristic of a write request and each of the mapped system characteristics of the data placement table. In some embodiments, the data placement table may be implemented as a look-up table or appropriate data structure to compare a system characteristic of the write request and each of the mapped system characteristics of the data placement table. If the processing circuitry determines that there is not at least one matching mapped system characteristic to one or more system characteristics, process 400 continues to subprocess A, which is shown in FIG. 5. When processing circuitry determines that there is at least one mapped system characteristics within the data placement table that matches one or more system characteristics determined from the information of the write request, process 400 proceeds to determine a location in the memory at which to store the data, step 408.

At step 408, processing circuitry determines a location (e.g., memory address) in the memory at which to store the data based on one or more placement IDs corresponding to matched mapped system characteristics of the data placement table and without regard to the destination address. In some embodiments, when there is more than one placement ID determined based on matched system characteristics, processing circuitry randomly selects one of the placement IDs at which to store the data of the write request. In other embodiments, the processing circuitry determines one placement ID which corresponds to multiple matched mapped system characteristics. In some embodiments, the determined location at which to store the data is determined based on the next available memory address which is offset from the base memory address associated with the placement ID. Once the processing circuitry determines the location in memory (e.g., memory address) at which to store the data, processing circuitry then causes the data to be stored at the location (e.g., the memory address corresponding to the determined placement ID), at step 410.

At step 410, processing circuitry causes the data to be stored at the determined location. In some embodiments, processing circuitry performs a write operation to store the data of the write request at the determined location.

FIG. 5 shows a flowchart of illustrative steps of a subprocess 500 for performing implicit data placement for data associated with unmapped system characteristics, in accordance with some embodiments of the present disclosure. In some embodiments, the referenced system, device, processing circuitry, I/O circuitry, memory, port, host, and write request may be implemented as system 100, device 102, processing circuitry 104, I/O circuitry 105, memory 106, port 107, host 108, and write request 110, respectively. In some embodiments, the subprocess 500 can be modified by, for example, having steps rearranged, changed, added, and/or removed.

At step 502, processing circuitry maps one or more system characteristics to an available placement ID. In some embodiments, available placement IDs may correspond to memory blocks or pages which have not been written to or contain stale or invalid data which may be overwritten or cleared. In some embodiments, each memory block of memory includes information indicative of whether each memory block is available (e.g., a valid bit). The placement table is therefore updated with the newly mapped system characteristics associated with the available placement ID. The updated placement table is then used for subsequent write requests received from the host. Although updating the placement table requires additional processing time and cost, any write request including respective data received from the host with one or more system characteristics which match the newly mapped system characteristics will be written to a location in the memory based on the corresponding placement ID of the matched mapped system characteristics.

At step 504, the processing circuitry stores the data at a location in memory based on the available placement ID. In some embodiments, the available placement ID points to a base memory address to which the data is stored. In some embodiments, once the data is stored at the location in memory based on the available placement ID, processing circuitry updates data associated with the available placement ID which indicates that the available placement ID may be written to. Updating this data, by the processing circuitry, may include setting a valid bit associated with the memory blocks which correspond to the available placement ID. In some embodiments, processing circuitry may update the valid bit associated with the memory blocks which corresponds to the available placement ID based on an age of the data stored at the memory blocks or other characteristics of the data which indicate the validity of the data.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching

[symbol]

What is claimed is:

1. A method for storing data on a device comprising memory, the method comprising:
receiving a write request from a host, the write request comprising information indicative of one or more system characteristics and a destination address at which to store the data;
determining the one or more system characteristics based on the information indicative of the one or more system characteristics;
determining whether any of the one or more system characteristics match with mapped system characteristics of a data placement table, wherein each respective mapped system characteristic corresponds to a respective placement identification (ID);
determining a location in the memory at which to store the data based on one or more placement IDs corresponding to matched mapped system characteristics of the data placement table and without regard to the destination address; and
causing, using the processing circuitry, the data to be stored at the location.

2. The method of claim 1, further comprising:
in response to determining that any of the one or more system characteristics does not match with the mapped system characteristics of the data placement table:
mapping the one or more system characteristics to an available placement ID; and
storing the data at a location in memory based on the available placement ID.

3. The method of claim 2, further comprising:
determining the available placement ID based on unused placement IDs and stale placement IDs, wherein each respective placement ID of the unused placement IDs and the stale placement IDs is associated with a respective available location of memory.

4. The method of claim 1, wherein the information indicative of one or more system characteristics comprises any one or more of:
a physical function,
a virtual function,
a namespace ID,
a submission queue ID,
a write operation length, and
a port ID.

5. The method of claim 1, wherein the host is a first host associated with a first port and wherein receiving a write request from a host comprises receiving a write request from one of a plurality of ports, each of which is associated with a respective host, wherein each respective port of the plurality of ports is associated with a respective port ID.

6. A device comprising:
memory; and
processing circuitry to:
receive a write request from a host, the write request comprising information indicative of one or more system characteristics and a destination address at which to store data;
determine the one or more system characteristics based on the information indicative of the one or more system characteristics;
determine whether any of the one or more system characteristics match with mapped system characteristics of a data placement table, wherein each respective mapped system characteristic corresponds to a respective placement identification (ID);
determine a location in the memory at which to store the data based on one or more placement IDs corresponding to matched mapped system characteristics of the data placement table and without regard to the destination address; and
cause the data to be stored at the location.

7. The device of claim 6, wherein the processing circuitry is further to:
in response to a determination that any of the one or more system characteristics does not match with the mapped system characteristics of the data placement table:
map the one or more system characteristics to an available placement ID; and
store the data at a location in memory based on the available placement ID.

8. The device of claim 7, wherein the processing circuitry is further to determine the available placement ID based on unused placement IDs and stale placement IDs, wherein each respective placement ID of the unused placement IDs and the stale placement IDs is associated with a respective available location of memory.

9. The device of claim 6, wherein the information indicative of one or more system characteristics comprises any one or more of:
a physical function,
a virtual function,
a namespace ID,
a submission queue ID,
a write operation length, and
a port ID.

10. The device of claim 6, wherein the host is a first host associated with a first port and wherein to receive a write request from a host the processing circuitry is to receive a write request from one of a plurality of ports, each of which is associated with a respective host, wherein each respective port of the plurality of ports is associated with a respective port ID.

11. A non-transitory computer-readable medium having non-transitory computer-readable instructions encoded thereon that, when executed by processing circuitry, cause the processing circuitry to:
receive a write request from a host, the write request comprising information indicative of one or more system characteristics and a destination address at which to store data;
determine the one or more system characteristics based on the information indicative of the one or more system characteristics;
determine whether any of the one or more system characteristics match with mapped system characteristics of a data placement table, wherein each respective mapped system characteristic corresponds to a respective placement identification (ID);
determine a location in the memory at which to store the data based on one or more placement IDs corresponding to matched mapped system characteristics of the data placement table and without regard to the destination address; and
cause the data to be stored at the location.

12. The non-transitory computer-readable medium of claim 11, wherein the processing circuitry is further to:
in response to a determination that any of the one or more system characteristics does not match with the mapped system characteristics of the data placement table:
map the one or more system characteristics to an available placement ID; and
store the data at a location in memory based on the available placement ID.

13. The non-transitory computer-readable medium of claim 12, wherein the processing circuitry is further to:
determine the available placement ID based on unused placement IDs and stale placement IDs, wherein each respective placement ID of the unused placement IDs and the stale placement IDs is associated with a respective available location of memory.

14. The non-transitory computer-readable medium of claim 11, wherein the information indicative of one or more system characteristics comprises any one or more of:
a physical function,
a virtual function,
a namespace ID,
a submission queue ID,
a write operation length, and
a port ID.

15. The non-transitory computer-readable medium of claim 11, wherein the host is a first host associated with a first port and wherein to receive a write request from a host the processing circuitry is to receive a write request from one of a plurality of ports, each of which is associated with a respective host, wherein each respective port of the plurality of ports is associated with a respective port ID.
